(19) United States
(12) Patent Application Publication
(10) Pub. No.: US 2013/0092768 A1
(43) Pub. Date: Apr. 18, 2013

(54) LANCE

(71) Applicants: Klaus Feichtinger, Linz (AT); Manfred Hackl, Linz-Urfahr (AT); Gerhard Wendelin, Linz (AT)

(72) Inventors: Klaus Feichtinger, Linz (AT); Manfred Hackl, Linz-Urfahr (AT); Gerhard Wendelin, Linz (AT)

(73) Assignee: Erema Engineering Recycling Maschinen und Anlagen Gesellschaft m.b.H., Ansfelden (AU)

(21) Appl. No.: 13/641,453

(22) PCT Filed: Apr. 13, 2011
(86) PCT No.: PCT/AT2011/000179

§ 371 Date: Dec. 21, 2012

(30) Foreign Application Priority Data
Apr. 16, 2010 (AT) A629/2010

(51) Int. Cl. B29B 17/02

(52) U.S. Cl. CPC B29B 17/02
USPC 241/20; 366/167.1; 366/168.1; 241/60

(57) ABSTRACT

Disclosed is a method for preparation and purification of a polymer material, wherein the polymeric material is agitated and heated in a receiving tank by a mixing tool, and wherein a rinse medium is introduced into an area below the level of the material under processing that is present below the level of the receiving container, into the interior of the storage container, wherein the rinse medium by forming a forced flow is passed at least through a partial area of the material and wherein the rinse medium is discharged from the storage tank in an area above the level of the material under processing that is present in the storage. The rinse medium is introduced into the receiving tank via at least one feed means that is arranged on at least one lance that projects from a side wall of the receiving tank into the interior space of the receiving tank.

Numerous plastic recycling applications suffer from problematic loading influences such as high residual moisture, large density fluctuations, loading portions that are too large, etc. As a result, the performance of the extruder connected at the outlet and the economy of the method are negatively influenced. The extruder suffers from these loading influences, which results in reduced and fluctuating ejection performance, uneven melting performance, reduced product quality, optionally elevated wear and on the whole in a reduced productivity.

It is especially unpleasant if the volatile substances are removed with the processed material from the receiving container and pass into the extruder, that is directly or indirectly connected to the receiving container, since there is then the danger that gaseous inclusions of differing types are present in the extruded material, which significantly reduces the quality of the material obtained at the extruder discharge. This danger can not be completely eliminated even by a degassing apparatus, that is usually provided in the extruder. In addition, such volatile substances or problematic substances can usually not be avoided from the beginning since they are water vapor, products released from the material to be processed, gaseous or evaporated cooling agent components, etc. In particular in the case of moist initial material these volatile problematic substance components can be significant.

Basically all substances are to be considered as problematic substances that exit from the material to be treated and/or separate from the introduced material and/or are possibly introduced even together with the material and which can entail a subsequent adverse influencing of the processing. The problematic substances can adhere to the outside of the surfaces of the material to be processed, as is the case in particular for wash water, surface coatings, etc., where they then evaporate, sublimate, separate from the surface or the like. However, the problematic substances can also be present in the matrix of the material or in the interior of the material and then diffuse outward during the course of the processing, where they evaporate, sublimate or the like. This can be observed in particular in the case of organic additives, for example, with softeners, but also water, monomers, gases or waxes can be present in the matrix. Thus, the problematic substances to be removed can also be sublimating solids or dust.

Apparatuses with two superposed mixing tools in the cutting compressor are known from the state of the art, e.g., from WO 00/74912 A1, that reduce these problems. Such apparatuses have proven themselves for the workup of thermoplastic plastic material in particular. Nevertheless, such apparatuses are usually not capable of completely removing all problematic substances, which has the consequence of an adverse affect on the workup or processing. There are problems in particular in the case of plastic materials with high external moisture such as, e.g., polyolefin washing chips, etc. Even materials with high internal moisture, e.g., PA fibers, are problematic. In this case condensation and evaporation can occur between the disks and mixing tools, for example, by the air saturated with moisture, which, for its part, results in an elevated energy requirement of the system in addition to the already mentioned disadvantages.

In order to further reduce this problem, an apparatus is known from EP 2 117 796 A1 in which a gas is introduced underneath the material level of the developing mixing thrombus inside the cutting compressor and the gas enriched with problematic substances is brought out again above the material level of the mixing thrombus. In this apparatus the gas is supplied via the bottom, via the side walls or via the mixing tools. The moisture and/or the problematic substances present in the material are effectively removed in this manner.

The present invention has the task of creating an advantageous, economical and effective method for removing as completely as possible undesired problematic substances that adversely affect the workup or further processing of the material.

The invention also has the task of creating an apparatus that has a simple construction, is stable and with which the washing medium can be efficiently introduced.

This task is solved with a method of the initially mentioned type by the characterizing features of Claim 1. The invention provides that the washing medium is introduced into the receiving container via at least one supply means that is arranged on at least one lance extending from a side wall of the receiving container into the inner space of the receiving container.

It surprisingly turned out in experiments that the arrangement of the supply means in accordance with the invention to the inwardly projecting lance has a noticeably positive influence on the flow through of the material with the washing media and as a result on the removal of the problematic substances. Therefore, the washing medium is introduced not only on the outermost edge of the receiving container or of the mixing thrombus—as is the case when the washing medium is introduced via openings in the bottom or in the side wall—but rather further in the interior of the container, as a result of which it can also be better and more uniformly distributed. Moreover, the washing medium is introduced via fixed and/or resting elements—in contrast to the introduction of the washing medium via rotating mixing tools. In this manner the dosing of the washing medium is solved in a constructively very simple manner and the washing medium can nevertheless be introduced even into areas located in the interior of the receiving container. Whereas when the washing medium is introduced via the mixing tools one is limited to the positions of the mixing tools, the lances in accordance with the invention can be arranged at any desired height and in any desired number in the receiving container. As a result, the particularities of the mixing thrombus and of the courses of movement of the particles can be taken into consideration and the most favorable point for adding in the doses can be selected. Furthermore, an inwardly projecting lance has the advantage that the material must press pass the lance on the side of the lance and the flakes are loaded on all sides and directly with washing medium, in contrast to which in the case of an introduction via the side wall only the outermost flow layer of the flakes is directly loaded with washing medium.

The method in accordance with the invention thus leads to a constructively simply solved and very effective removal of problematic substances with a low use of washing medium at the same time.

Further advantageous embodiments of the invention are described in the dependent claims.

It is important that the washing medium is always introduced at one height below the level of the material, whereby it is additionally advantageous if the washing medium is introduced into the receiving container in the area of the lower third of the height of the receiving container. In addition there is a loosening of the sump by blowing in a washing medium from below, as a result of which an even better workup of the material is ensured. This causes an intensive mixing and a good distribution of the washing medium in the material in this area.

It is advantageous in this connection if it is provided that the washing medium is introduced into the receiving container in the area below the mixing tool closest to the bottom. Problematic substances often stubbornly settle particularly in this area with a relatively low turbulence and are also effectively brought out of the sensitive area in this manner.

The supply means advantageously do not empty in the area of the edges of the carrier disks or of the mixing tools, but rather it is provided that the washing medium is introduced—given the presence of two or more superposed mixing tools—into the receiving container in the area between the mixing tools, as a result of which an effective cleaning takes place even in this area.

A proven embodiment provides that the washing medium is introduced in the area of the container in which the material particles moved and/or rotating in the receiving container exert the highest pressure on the side wall of the receiving container.

It is advantageous in this connection if the washing medium is a gaseous medium, in particular air or an inert gas.

The washing medium is advantageously heated and/or pre-dried by a heating apparatus or a gas drying apparatus connected in upstream before it passes into the receiving container. In this manner the removal of the problematic substances and the carrying out of the method can be effectively influenced and controlled.

The polymer material is present in the receiving container permanently in lumps and in particles and is in a softened and slightly pasty state in which the individual particles are adhesive but not molten. As a result of the movement of the mixing tools the adhesive particles are still kept flowable and in lumps.

After an appropriate dwell time it is provided that the polymer material is brought out via a worm whose housing is connected by a draw-in opening to a discharge opening of the receiving container, preferably via an extruder, whereby the discharge opening is arranged in the side wall near the bottom area of the receiving container.

The previously cited task is furthermore solved by an apparatus of the initially cited type in which apparatus it is provided that at least one lance extending inwardly from the side wall is arranged on a side wall of the receiving container and that the supply means is arranged on the lance.

This makes it possible to introduce gas and/or washing medium into the receiving container in an uncomplicated manner with a very simple construction. Furthermore, the washing medium can be introduced not only entirely on the outside but also in areas of the receiving container located further inward, where it can be well distributed, accelerating and improving the cleaning effect.

According to a constructively simple and stable embodiment it is provided that the lance is aligned parallel to the mixing tool or normally to the axis and/or that the lance is directed inward substantially radially or slightly offset, or inclined to the radial.

A stable embodiment with favorable rheology provides that the lance is substantially plate-shaped with a relatively small thickness, with an upwardly facing upper surface that is optionally aligned parallel to the bottom surface and with an opposite bottom surface that faces downward and is preferably aligned parallel to the upper surface. In this manner the flakes brush past the lance on both sides.

In this connection it is especially advantageous as concerns the technology of friction and rheology if it is provided that the lance and/or the surface has the form of a shark's fin, with a curved and preferably rounded front edge facing the direction of the movement and rotation of the mixing tool and a straight or curved rear edge situated downstream, whereby the front edge and the rear edge preferably come together to a tip.

A constructively simple embodiment provides that the supply means are designed as individual, singular openings or as nozzles with a diameter between 10 and 30 mm, preferably about 20 mm.

In order to avoid adhesions of the supply means it is advantageous if the supply means terminate flush with the outer surface of the lance.

In order to make use of the fact that the flakes brush past the lance on both sides, it is advantageous if the supply means are formed or arranged on the upper surface as well as on the bottom surface. In this manner the cleaning performance can be raised or doubled.

It can be advantageous for some materials if the supply means are formed or arranged if necessary even exclusively in or on the rear edge, on which there is only a slight or even no dynamic pressure by the materials running toward it.

In order to increase the cleaning performance it is advantageous if several supply means are formed or arranged on each lance, preferably in rows running parallel to the front edge or the rear edge. More gas can be blown into the interior of the receiving container in this constructively simple manner.

Between 3 to 8 openings are advantageously provided on each lance, whereby the total opening area of all openings formed on one or all lances is advantageously between 380 mm² and 6000 mm².

Problematic substances frequently collect in the area under the mixing tool closest to the bottom, for which reason it is advantageous to arrange a lance there.

If the lance is arranged in the area of the lower third of the height of the receiving container the sump is also efficiently stirred up and the cleaning efficiency increased.

Another advantageous embodiment provides that at least two superposed mixing tools are provided in the receiving container and that the lance is arranged in the area, preferably centrally, between the mixing tools.

Furthermore, it can be advantageous if the lance is arranged in the area of the side wall of the container in which area the material particles moved and/or rotating in the container exert the greatest pressure on the side wall of the container.

In order to further increase the cleaning action it is advantageous if several lances are provided that are arranged, preferably regularly distributed, at the same height over the circumference of the side wall of the receiving container.

The supply means can be arranged on the outside of the lance surface and be supplied via external conduits with washing medium.

However, an especially advantageous embodiment provides that the lance is hollow or that a conduit or hollow space is formed in the lance that has a fluid connection with an area outside of the receiving container through which area the washing medium can be introduced and can flow to the supply means. This constructively simple solution ensures a reliable introduction of gas.

Alternatively, a rod-shaped lance can also be used, for example, a hollow small tube.

In order to introduce the washing medium as far as possible into the interior of the receiving container it is advantageous if the lance extends at least over a length of greater than or equal to 10%, preferably 20% of the radius of the receiving container.

In this connection that is especially advantageous if the supply means of each lance located furthest inward has a radial distance to the side wall of greater than or equal to 10%, preferably 20%, of the radius of the receiving container. In this manner the washing medium is distributed uniformly into the polymer flakes.

Since the form of the mixing thrombus and the paths which the polymer particles take in the receiving container, caused by the mixing tools, are a function of the materials and the speeds and therefore do not always run identically, it is advantageous if the lance is rotatably fastened on the side wall and/or if the angle of inclination or the adjustment angle of the lance to the bottom surface and/or the angle of the upper surface to the bottom surface are adjustable. The adjustability should be at least in a range of ±45° from the horizontal middle position. In this manner the most favorable position from a rheological standpoint or the position at which the loading of the particles with washing medium is most efficient can be adjusted.

In order to prevent an entrainment of material particles by too strong a removal by suction, it is advantageous to arrange the removal means as far as possible from the material level. In particular, it is advantageous if at least one removal means for the discharge of the washing medium enriched or saturated with problematic substances from the container is provided in the receiving container above the level of the material present in the operation in the receiving container or above the material level of the mixing thrombus, for example, an opening in the container cover or in the container wall.

A constructively stable and proven embodiment provides that the receiving container is substantially cylindrical with a level bottom surface and with a side wall shaped like a cylinder jacket and aligned vertically to this bottom surface and/or that the axis of rotation coincides with the central middle axis of the receiving container, and/or that the axis of rotation or the central middle axis is aligned vertically or normally to the bottom surface.

In order to bring the material out of the receiving container after a certain dwell time, it is provided that at least one worm, preferably an extruder, is provided for removing the material from the receiving container, the housing of which worm is connected, for example, radially or tangentially by a draw-in opening to a discharge opening of the receiving container, whereby the discharge opening is arranged in the side wall in the vicinity of the bottom surface of the receiving container.

The supply means can be constructed as passive supply means, for example, as mere passage openings through which the washing medium is drawn in only passively, for example, by a vacuum in the cutting compressor into the interior of the cutting compressor. However, the supply means can also be designed as active supply means, for example, as nozzles or the like through which the washing medium can be blown in, sprayed in or pumped into the interior of the cutting compressor actively, for example, by pumps, blowers etc. with an excess pressure.

Likewise, the removal means can be designed as passive removal means through which the washing medium is forced and passes solely by excess pressure in the receiving container, or are designed as active removal means loaded, for example, by suction pumps.

In order to regulate the supply and removal of the washing medium the supply means and/or removal means can be closed and/or regulated at least partially.

The invention is described in the following using especially advantageous exemplary embodiments which are not to be understood as being limiting and which are schematically shown in the drawings.

FIG. 1 shows a vertical section through an apparatus in accordance with the invention in accordance with a first exemplary embodiment.

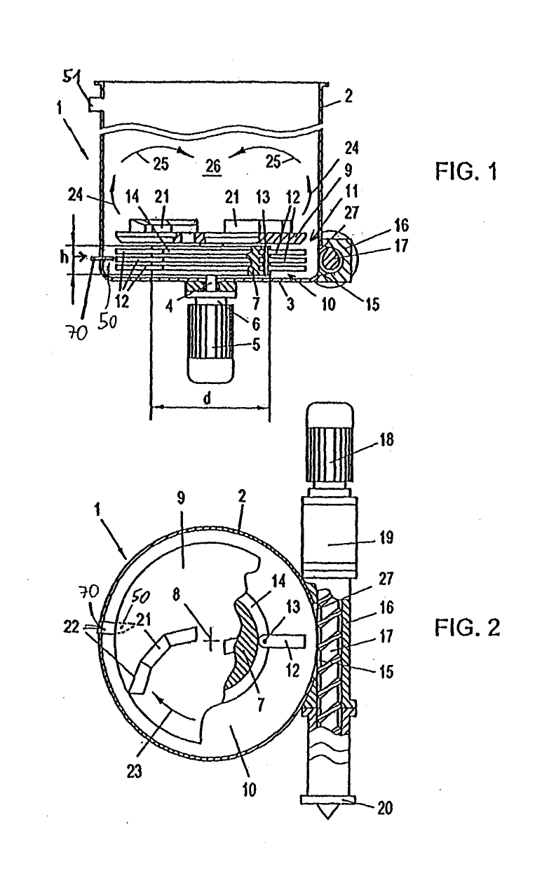

FIG. 2 shows another embodiment in a top view.

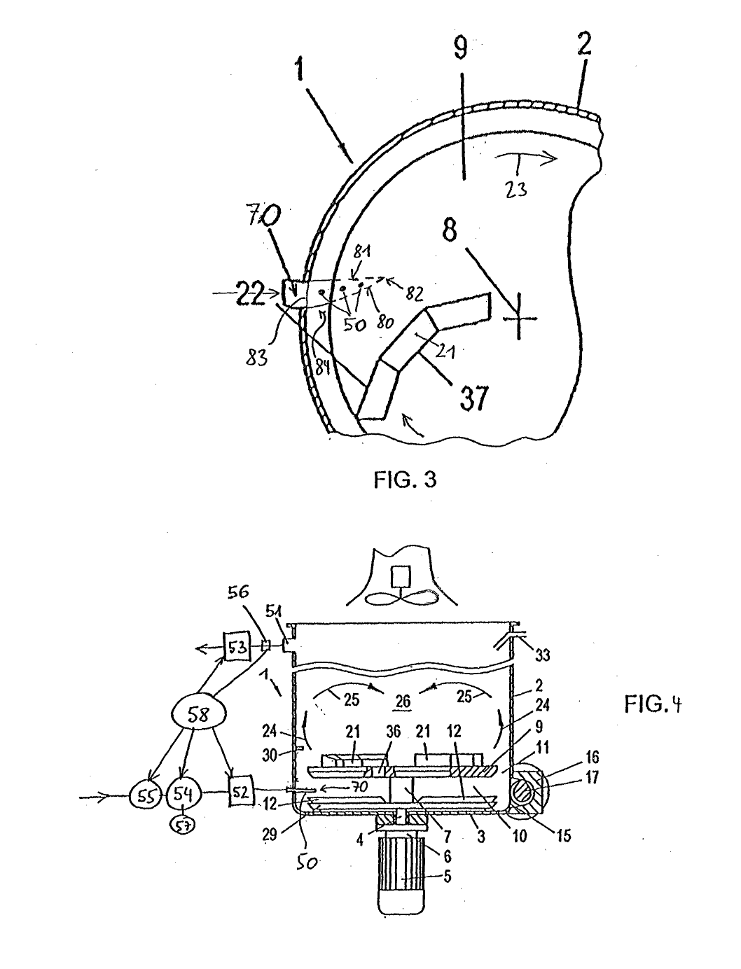

FIG. 3 shows a detail of another embodiment in an enlarged view.

FIG. 4 shows another exemplary embodiment in vertical section.

In the exemplary embodiment according to FIG. 1 the apparatus comprises a receiving container and cutting compressor, called container 1 in the following, for the especially thermoplastic plastic material to be processed, which is introduced into this container 1 from above by a transport apparatus, e.g., a conveyor belt, which is not shown. The supplied plastic material can be pre-comminuted and/or pre-dried.

Container 1 is shaped like a cylindrical cup with vertical side walls 2 and a horizontal, level bottom surface 3 with a circular cross section. Container 1 can be tightly closed at the top and can be evacuated or open. A shaft 4 supported in a sealed manner runs through bottom surface 3 and has a vertical axis 8 that coincides with the container axis. Shaft 4 is driven by a motor 5 with transmission 6 for the rotary motion, which motor is arranged underneath bottom surface 3.

A rotor 7 and a carrier disk 9 arranged above it are connected to shaft 4 in such a manner that they rotate with it. Rotor 7 is formed by a circular cylindrical block whose axial extension h is significantly greater than that of flat carrier disk 9, but whose radial extension d is significantly smaller than that of carrier disk 9. In this manner a free space 10 is formed underneath carrier disk 9 which space has a free flow connection for the processed material with space 26 of container 1, which space 26 is located above carrier disk 9, via an annular slot 11 located between the circumference of carrier disk 9 and side wall 2 of container 1. The treated plastic material can pass through this free annular slot 11 in an unimpeded manner from upper space 26 into annular space 10 located beneath it.

Upper carrier disk 9 carries permanently arranged upper mixing tools 21 on its upper side which tools mix and/or comminute and/or heat the material present in space 26 of container 1. For an effective comminution tools 21 can be formed with cutting edges 22 that can be formed curved or bent counter to the direction of rotation of carrier disk 9 (arrow 23), as is the case, for example, in the embodiment of FIG. 2 or 3, in order to achieve a pulling cut.

During operation a rotation of the plastic mass introduced into container 1 results during the rotation of carrier disk 9 by the influence of tools 21, whereby the processed material rises up along side wall 2 of container 1 in space 26 (arrow 24) and falls back down again in the area of the container axis (arrow 25). The mixing thrombus produced in this manner thoroughly swirls the introduced material so that a good mixing effect is achieved.

The material introduced into container 1, where it is comminuted, if necessary, gradually passes through annular slot 11 into space 10 located underneath carrier disk 9 and is processed there by other, lower mixing tools 12 close to bottom surface 3 which are pivotably fastened on rotor 7 by vertical bolts 13 in annular grooves 14 of rotor 7 in such a manner that these tools 12 can freely oscillate about the axes of bolts 13. The free ends of lower tools 12 are at a distance from side wall 2 of container 1. These lower tools 12 bring about an additional mixing and/or comminution and/or heating of the material present in space 10 by their striking action.

As a result of the centrifugal force exerted by these lower tools 12 close to the bottom on the material the material is transported into a discharge opening 15 of container 1 which opening is approximately at the height of the additional lower tools 12 and connects space 10 of container 1 with a draw-in opening 27 of a worm housing 16 in which housing a worm 17 is rotatably supported that is driven on its one front end by a motor 18 with transmission 19 into a rotary motion, and presses out the material supplied to it on its other front end, e.g., by an extruder head 20. This can be a simple worm, a double worm or a multiple worm. As can be seen, worm housing 16 is connected approximately tangentially to the container so that deflections of the material plastified by worm 16 in the area of its discharge from housing 16 are avoided. Instead, worm 17 can also be a pure transport worm that supplies the material worked up in container 1 to further usage, e.g., to an extruder.

During operation a state of equilibrium develops after a brief intake time between the material removed by the worm and the material entering through annular slot 11 from above into space 10. This has the consequence that it is very unlikely that a plastic particle introduced into container 1 passes into worm housing 16 without having previously spent a sufficient dwell time in container 1. This ensures a sufficient processing of all plastic particles by mixing tools 12, 21, so that the material removed by worm 17 has an at least approximately uniform nature, in particular as regards the temperature and the size of the plastic particles. This means that the plasticizing work to be performed by worm 17 or the connected extruder worm is comparatively small so that high thermal peak loads on the plastic material during the plasticizing work are eliminated. This protects the plastic material and significantly saves drive energy for worm 17 and/or the extruder worm.

As initially mentioned, the material introduced into container 1 is as a rule not completely dry and/or it contains impurities that emit volatile substances during the processing in the container, e.g., water vapor, products released from the material to be processed, evaporated cooling agent, volatile substances from coloring material and/or printing material, etc. In order to effectively remove these problematic substances or to avoid that these volatile substances collect, for example, in space 10 underneath upper carrier disk 9 and thus hinder the passage of processed material from space 26 into space 10 and/or pass into the interior of worm housing 16, a lance 70 extending into the interior of container 1 is arranged in the lower area of side wall 2 of container 1. Several supply means 50 in the form of openings or nozzles are arranged on this lance 70 via which a washing medium, e.g., a gas, can be blown from an area outside of container 1 under pressure into the interior of container 1. Supply means 50 are formed as singular openings in surface 83 of lance 70 and have a diameter of about 20 mm. More specific details for lance 70 are described for FIG. 3.

Lance 70 is arranged fixed in its position in side wall 2 in the area under the upper mixing tools 21 or of upper carrier disk 9 and thus empties into the lower inner space part 10.

Lance 70 is arranged at such a height or at such a distance from bottom surface 3 that it is constantly located below the level, given in accordance with the method, of the material particles present and/or rotating in cutting compressor 1 or below the level of the mixing thrombus formed during the motion or rotation of the material particles. In addition, lance 70 is located in the area of the lower third of the entire height of cutting compressor 1.

In the embodiment of FIG. 1 lance 70 extends from side wall 2 until just before the outermost free ends of mixing tools 12.

Additionally, even other lances 70 can be formed distributed at the same height, in particular uniformly distributed over the circumference.

A removal means 51 in the form of an active removal of gas by suction or of a suction pump 53 is provided in the area above the material level. Alternatively, removal means 51 can also be constructed as a passive removal means.

Thus, dry, heated air can be blown with pressure into the interior of container 1 by supply means 50. This air is conducted upward by the forced flow being created through the moved material and absorbs present moisture and entrains the problematic substances. The area enriched with problematic substances leaves receiving container 1 via suction removal 51. A residual material that is almost free of problematic substances remains. In this manner the material can be almost completely freed of problematic substances by the advantageous synergistic cooperation of gas conduction 50, 51, of the two mixing tools 12, 21 and optionally of a perforation 36.

FIG. 2 shows a device which is very similar to the device in FIG. 1. Here, however, the lower mixing tools 12 near the bottom are not spaced so tight and closely above each other, and the lance 70 can therefore be partially arranged between two superposed levels of mixing tools 12 and/or project into there in sections. The anterior section of the lance 70 represented as a dashed line is partially covered by the upper carrier disc 9 in the horizontal projection of FIG. 2. As a result, the lance 70 can also extend further to the inside; in the present case it has a length that is approximately 20% of the radius. The lance 70 therefore extends beyond the outermost circle of rotation of the mixing tools 12, whereby the rinse medium can be brought even further toward the inside than with FIG. 1.

FIG. 3 shows a detail of a further advantageous embodiment in a magnified view. A lance 70, as it is represented here, can be used in all devices of FIG. 1, 2, or 4.

The exemplary lance 70 shown in FIG. 3 is essentially lamellar and has a relatively small thickness. The lance 70 has an upper surface 83, facing to the top and a lower surface 84 facing to the bottom in the direction of the floor area 3. The upper surface 83 is aligned parallel to the lower surface 84 and to the floor area 3. When viewed from the top, the lance 70 has the basic shape of a shark fin. The front edge 80 that is facing the material flowing against it, is curved. The trailing edge 81 positioned downstream runs straight in FIG. 3, however it can also be curved same as with a shark fin. The front edge 80 and the trailing edge 81 converge into a tip 82.

The front edge 80 is not blunt or straight, but is designed rounded, so that it has a lower flow resistance against the particles that flow against it in the direction of arrow 23.

The lance 70 extends across a length measured from the side wall 2 up to the point 82 approximately 30 to 35% into the interior of the receiving container 1. The feed means 50, shown at the extreme right in FIG. 3, which is positioned furthest to the inside and/or at the furthest distance from the side wall, is spaced from the side wall 2 at an approximate radial distance of 20 to 25% of the radius of the container. In this manner, the rinse medium and/or gas can be brought far to the inside.

In this instance, the lance 70 can be pivoted on the side wall 2 in order to adjust the angle of inclination and so that it can be adapted optimally to special flow conditions.

The lance 70 is not completely radially oriented to the inside and/or aligned such that an intended extension to the inside goes past the rotational axis 8 on the outflow side.

The lance 70 is located below a carrier disk 9 on which the mixing tools 21 are arranged. For this reason, the foremost portion of the lance is covered by the carrier disc 9 and is drawn as a dashed line.

Three feed means 50 are formed on the upper surface 83 of the lance 70, which are arranged in a row that runs essentially parallel to the front edge 80. In this instance, it involves apertures or nozzles that are spaced apart, which terminate flush with the upper surface 83. Feed means 50 are also formed on the opposite lower surface 84. The lance 70 is hollow on the inside and/or has a channel or a hollow space that is connected with an area outside of the receiving container 1. The rinse medium is introduced into the interior of the lance 70 by means of this channel and reaches the feed means 50 and subsequently into the interior of the receiving container 1.

An alternative embodiment pursuant to FIG. 4 differs from that in FIGS. 1 and 2 especially in that the lower mixing tools 12 that are close to the bottom are not suspended pivoting, but are placed rigidly onto a further lower carrier disc 29, which is arranged coaxially to carrier disc 9 and which can be driven via the same shaft 4 for rotary motion. As a result, the rotor 7 can be designed narrower or be completely dispensed with as an extension of the shaft 4. As in the embodiments pursuant to FIGS. 1 and 2, the lower mixing tools 12 are arranged at the height of the discharge opening 15 of the container 1, so that the processed plastic material in space 10 can be conveyed effectively into the feed opening 27 of the worm casing 16. The area below the lower carrier disc 29 is very small.

As previously illustrated in FIGS. 1 and 2, the lance 70 is arranged between the carrier disc 9, 29 and/or between the upper and the lower mixing tools 21, 12, and discharges into the free space 10 that is larger now. The lance 70 extends up to a depth of approximately 20% of the radius to the inside.

It is advisable to monitor the temperature of the process material in container 1. As shown in FIG. 4, a pyrometer 30 and a cooling device 33 are provided in the upper cutting space 26 above the carrier disc 9. The removal of the volatile interfering substances entering the upper cutting space 26 can be assisted by an extraction system 51. A measuring device 56 is arranged in the path of the gas that is discharged from container 1 to measure the temperature of the gas being discharged and/or its humidity and/or the content of the interfering substances in this gas. The device and/or its individual elements can be controlled and/or adjusted by means of a schematically illustrated control device 58. In the present case, the control device 58 is connected with the discharge means 51 and the feed means 50. A heater unit 54 as well as a gas drying unit 55 and a pump or blower unit 52 are positioned in the path of the supplied gas. Using these units, assisted by the action of the control device 58, the quantity and/or the temperature and/or the pressure of the supplied gas can be controlled. Is also possible to utilize the temperature and/or the humidity of the gas being discharged for controlling the temperature and/or quantity and/or the pressure of the supplied gas.

In FIG. 4, the carrier disc 9 has at least one, however preferably several openings 36 which connect the space 26 above the carrier disc 9 with the space 10 located below it. As a result of these openings 36, the retained volatile substances in space 10 can escape toward the top passing through the carrier disc 9 and thus out of the container 10, and be discharged by an extraction system 51, for example. The openings 36 are optional and in addition assist with the cleaning, but they can also be omitted, however. The openings 36 can be formed by bores, the cross section of which is circular or slotted. At least some of these openings 36 are arranged near the axis 8 of the container 1, i.e. immediately behind the tools 21, so that the openings 36 when viewed in the direction of rotation (arrow 23) of the carrier disc 9, are adjacent to the borders and and/or trailing edges of the tools 21. The suction effect caused by the trailing edge of the tools 21 during their rotation assists with the evacuation of the volatile substances through the openings 36 to the top.

A further advantageous embodiment (which is not shown, however) has a container 1, in which merely a single carrier disc 9, 29 with mixing tools 12, 21 is provided in the lower section barely above the floor area 3 at the height of the discharge opening 15. The mixing tools 12, 21 create agitation of the material particles and/or a mixing thrombus 25. In the side wall 2 of container 1, i.e. at the height at which the highest pressure is exerted onto the side wall 2 by the agitated material particles, a lance 70 is arranged through which the flush gas is blown into the interior of the container 1.

1-26. (canceled)

27. A method for preparation and purification of a polymer material, wherein the existing polymeric material which is lumpy and not molten, is agitated and heated in a receiving tank (1) by at least one mixing and/or comminution tool (12, 21), and wherein for the removal of undesirable interfering substances which impair the preparation or the further processing of the material, a rinse medium is introduced into an area below the level of the material under processing that is present in the receiving container (1) and/or below the level of the material of the mixing thrombus being formed, into the interior of the receiving container (1), wherein the rinse medium, by forming a forced flow, is passed at least through a partial area of the material and wherein the rinse medium, which is now concentrated and/or saturated with interfering substances is subsequently discharged from the receiving tank (1) in an area above the level of the material under processing that is present in the receiving tank (1) and/or above the material level of the mixing thrombus, and wherein the rinse medium is introduced into the receiving tank (1) via at least one feed means (50) that is arranged on at least one lance (70) that projects from a side wall (2) of the receiving tank (1) into the interior space of the receiving tank (1) characterized in that the lance (70) is essentially lamellar and has a relatively small thickness, with an upper surface (83) that faces to the top and which is aligned parallel to the floor area (3), if necessary, and an opposite lower surface (84) that is facing down and that is preferably aligned parallel to the upper surface (83).

28. A method according to claim 27, characterized in that the rinse medium is introduced into the receiving container (1) in the area of the lower third of the height of the receiving container (1).

29. A method according to claim 27, characterized in that the rinse medium is introduced into the receiving container (1) in the area below the mixing tool (12, 21) that is closest to the bottom.

30. A method according to claim 27, characterized in that the rinse medium is introduced in the area between the mixing tools (12, 21) into the receiving container (1), if two or more superimposed mixing tools (12, 21) are present.

31. A method according to claim 27, characterized in that the rinse medium is introduced into that area of the container (1) in which the agitated and/or rotating material particles exert the highest pressure onto the side wall (2) of the receiving tank (1).

32. A method according to claim 27, characterized in that the rinse medium is a gaseous medium, in particular air or an inert gas and/or is heated and/or dried prior to being supplied and/or that the polymer material in the receiving tank (1) is present in the form of thermoplastic polymer particles and/or flakes, and that the polymer material is permanently lumpy and/or in the form of particles, is softened, however not molten.

33. A method according to claim 27, characterized in that the polymer material is discharged via a screw (17) the housing of which (16) is connected with a feed opening (27) to a discharge opening (15) of the receiving container (1), preferably via an extruder, wherein the discharge opening (15) in the side wall (2) is arranged near the floor area (3) of the receiving container (1).

34. A device for performing the method according to claim 27, with at least one receiving tank (1), in which at least one mixing tool (12, 21) which is rotatable around an axis (8) is arranged, with which during operation a polymer material presented in the interior of the receiving container (1) is agitated, mixed, heated and comminuted, if necessary, wherein in the receiving tank (1), below the level of the material under processing in the receiving container (1) and/or below the material level of a mixing thrombus being formed under processing, a feed means (50) for the ingress of a rinse medium into the interior of the receiving tank (1) is provided, and wherein on a side wall (2) of the receiving tank (1) at least one lance (70) that projects from the side wall (2) to the inside is arranged and that the feed means (50) is arranged on the lance (70), characterized in that the lance (70) is essentially lamellar and has a relatively small thickness, with an upper surface (83) that faces to the top and which is aligned parallel to the floor area (3), if necessary, and an opposite lower surface (84) that is facing down and that is preferably aligned parallel to the upper surface (83).

35. The device according to claim 34, characterized in that the lance (70) is aligned parallel to the mixing tool (12, 21) or normal to axis (8) and/or that the lance (70) essentially points radially to the inside.

36. The device according to claim 34, characterized in that the lance (70) and/or the upper surface (83) has the form of a shark fin, which has a curved, and preferably rounded front edge (80) facing in the direction of agitation and/or rotation of the mixing tool (12, 21) and a straight or curved trailing edge (81) positioned downstream, wherein the front edge (80) and the trailing edge (81) preferably converge to a tip (82).

37. The device according to claim 34, characterized in that the feed means (50) are formed as individual, singular apertures or nozzles, preferably with a respective diameter between 10 and 30 mm, and/or that the feed means (50, 50a,50b) terminate flush with the outer surface of the lance (70).

38. The device according to claim 34, characterized in that the feed means (50) are formed or arranged both on the upper surface (83) as well as on the lower surface (84).

39. The device according to claims 34, characterized in that the feed means (50), are formed or arranged, if necessary exclusively, in and/or on the trailing edge (81).

40. The device according to claim 34, characterized in that on each lance (70) multiple feed means (50) are formed or arranged preferably in rows that run parallel to the front edge (80) or the trailing edge (81), in particular 3 to 8 apertures, wherein the total aperture area of all apertures formed on one or all lances (70) is between 380 mm² and 6000 mm².

41. The device according to claim 34, characterized in that the lance (70) is arranged below the lowest mixing tool (12) that is closest to the bottom.

42. The device according to claim 35, characterized in that the lance (70) is arranged in the area of the lower third of the height of the receiving container (1).

43. The device according to claim 34, characterized in that in the receiving container (1) at least two mixing tools (12, 21) that are arranged superposed are provided and that the lance (70) is arranged preferably centered in the area between the mixing tools (12, 21).

44. The device according to claim 34, characterized in that the lance (70) is arranged in that area of the side wall (2) of the container (1) in which the agitated and/or rotating material particles exert the highest pressure onto the side wall (2) of the container (1).

45. The device according to claim 34, characterized in that multiple lances (70) are provided which are arranged at equal height across the circumference of the side wall (2) of the receiving container (1), preferably at regular intervals.

46. The device according to claim 34, characterized in that the lance (70) is hollow or that a channel or hollow space is formed in the lance (70) which has a fluid connection to an area outside of the receiving container (1), through which the rinse medium can be introduced and can flow to the feed means (50).

47. The device according to claim 34, characterized in that the lance (70) extends at least across a length that is larger than 10%, preferably 20%, of the radius of the receiving container (1).

48. The device according to claim 34, characterized in that the feed means (50) that is positioned furthest on the interior of each lance (70) has a radial distance to the side wall (2) of larger than 10%, preferably 20%, of the radius of the receiving container (1).

49. The device according to claim 34, characterized in that the lance (70) is pivoted on the side wall (2) and/or the angle of inclination and/or clearance angle of the lance (70) and/or the angle of the upper surface (83) to the floor area (3) is adjustable.

50. The device according to claim 34, characterized in that in the receiving container (1) above the level of the material under processing that is present in the receiving container (1) and/or above the material level of the mixing thrombus, at least one removal means (51) for discharging the rinse medium that is concentrated and/or saturated with interfering substances from the receiving container (1) is provided, such as an aperture in the container cover or in the container wall.

51. The device according to claim 34, characterized in that the receiving container (1) is essentially cylindrical with an even floor area (3) and a side wall (2) shaped as a cylindrical surface which is aligned vertically relative to said floor area, and/or the rotational axis (8) coincides with the central central axis of the receiving container (1) and/or the rotational axis (8) or the central central axis are aligned vertically and/or normally to the floor area (2).

52. The device according to claim 34, characterized in that at least one screw (17), preferably an extruder, for removal of the material from the receiving container (1) is provided, the housing (16) of which is connected with a feed opening (27) to a discharge opening (15) of the receiving container (1) radially or tangentially, for example, wherein the discharge opening in the side wall (2) is arranged near the floor area (3) of the receiving container (1).
